(19) United States
(12) Patent Application Publication
(10) Pub. No.: US 2010/0192580 A1
(43) Pub. Date: Aug. 5, 2010

(54) Combustion System Burner Tube

(76) Inventors: Derrick Walter Simons, Greer, SC (US); Leonid Zvedenuk, Moscow Region (RU); Sergey Anatolievich Meshkov, Moscow (RU); Valery Mitrofanov, Moscow (RU)

Correspondence Address: NIXON & VANDERHYE P.C., 901 NORTH GLEBE ROAD, 11TH FLOOR, ARLINGTON, VA, 22203, US

(21) Appl. No.: 12/364,854

(22) Filed: Feb. 3, 2009

(51) Int. Cl. F02C 1/00

(52) U.S. Cl. 60/737; 60/742; 60/748

(57) ABSTRACT

A combustor includes a burner tube that receives fuel for combustion from a fuel delivery system. An axial swirler is installed in the burner tube. The burner tube is flared downstream of the swirler. The structure provides for improved combustion stability while extending lean blowout and low frequency dynamics margins, which in turn serve to further reduce NOx emissions.

### BACKGROUND OF THE INVENTION

The invention relates generally to aerodynamic performance of a gas turbine combustor and, more particularly, to a premix fuel nozzle having a configuration with improved flame stability and lean blowout margins enabling a reduction in the production of nitrogen oxide (NOx) and other pollutants.

FIG. 1 shows a fuel nozzle arrangement in an existing combustor. The typical system includes a plurality of primary fuel nozzles 10 arranged in an annular array around a secondary fuel nozzle 12. The primary nozzles 10 are separated from the secondary nozzle 12 by a venturi throat region 14.

The secondary fuel nozzle 12 serves to maintain a pilot flame so that combustion continues downstream from the venturi throat region 14 once the flames upstream of the venturi throat region 14 have been extinguished. The stability of this pilot burner is directly related to overall performance of the combustor in terms of being able to split fuel between the primary and secondary sub-systems and achieve low emissions while not crossing or nearing lean blowout and dynamics thresholds.

The existing configuration shown in FIG. 1 incorporates a burner tube having an axial swirler 16 attached to a cylindrical passage 18. The swirled flow exiting the cylindrical passage 18 is designed to interact with an axial annular jet downstream of the venturi throat region 14. This configuration results in insufficient lean blowout and low frequency dynamics margins while tuning the fuel system to meet the ultra low NOx challenge.

In terms of combustion stability, a disadvantage of the existing system is that a recirculation region formed downstream of the swirler is limited by the boundaries of the cylindrical passage, and, according to a CFD (computational fluid dynamics) analysis, the recirculation region is squeezed by the venturi annular jet. The recirculation region formed downstream of the inner swirler starts somewhat away from the bluff body of the swirler (the tip of the secondary fuel nozzle) and extends further downstream past the cylindrical passage into a liner. As the flow leaves the cylindrical tube 18, it interacts with the flow that goes out of the venturi throat region 14. This interaction impacts the location and shape of the recirculation region, which is one of the primary contributors to combustion stability and lean blowout capability of the system.

Another existing system is disclosed in U.S. Patent Publication No. 2005/0034457. This system accelerates flow by means of a flared burner tube such that the flared burner tube forms an inner portion of a restriction for the flow exiting an array of multiple burners. It may preferable, however, to incorporate both the venturi and the flared burner tube in flow acceleration to affect the flow direction and thereby provide a more effective recirculation region.

### BRIEF DESCRIPTION OF THE INVENTION

In an exemplary embodiment, a secondary fuel nozzle is positionable among an annular array of primary fuel nozzles, where the primary fuel nozzles are separated from the secondary fuel nozzle by a venturi throat region. The secondary fuel nozzle includes a premix passage in fluid communication with a fuel delivery system, a swirler disposed downstream of the fuel delivery system in the premix passage, a conical diverging exit passage downstream of the swirler.

In another exemplary embodiment, a combustor includes a burner tube receiving fuel for combustion from a fuel delivery system, and an axial swirler installed in the burner tube. The burner tube is flared downstream of the swirler.

In yet another exemplary embodiment, a method of improving combustion stability in a combustor includes the steps of positioning a swirler in a burner tube that receives fuel for combustion from a fuel delivery system; and designing a portion of the burner tube downstream of the swirler to define a recirculation region that extends lean blowout and low frequency dynamics margins of combustion.

### BRIEF DESCRIPTION OF THE DRAWINGS

FIG. 1 is an internal cross-sectional view of a conventional combustion system; and

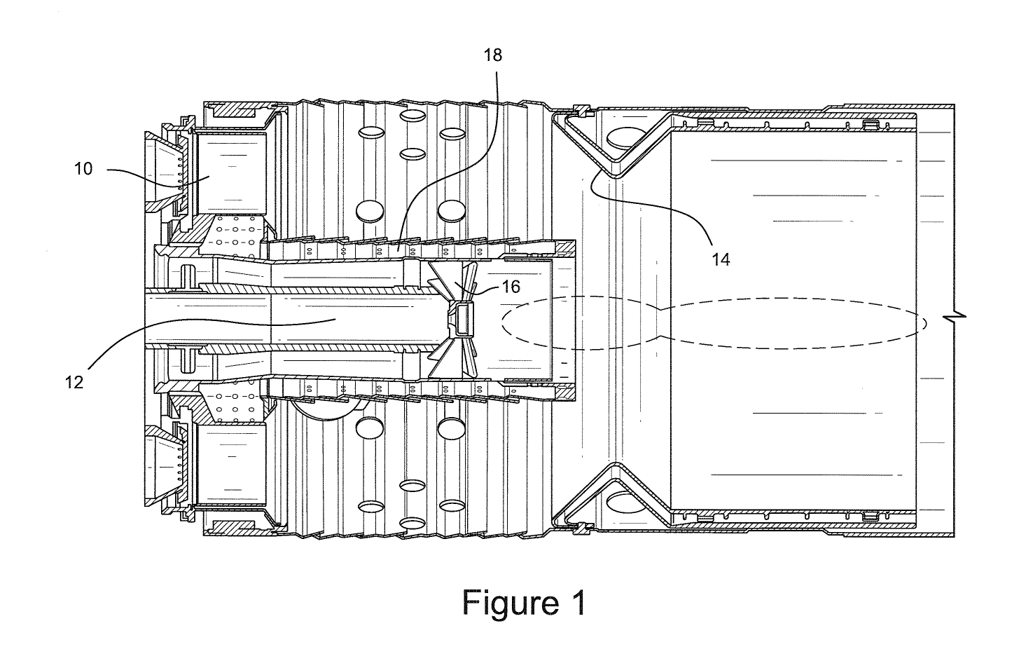

FIG. 2 is an internal cross-sectional view of the described combustion system.

### DETAILED DESCRIPTION OF THE INVENTION

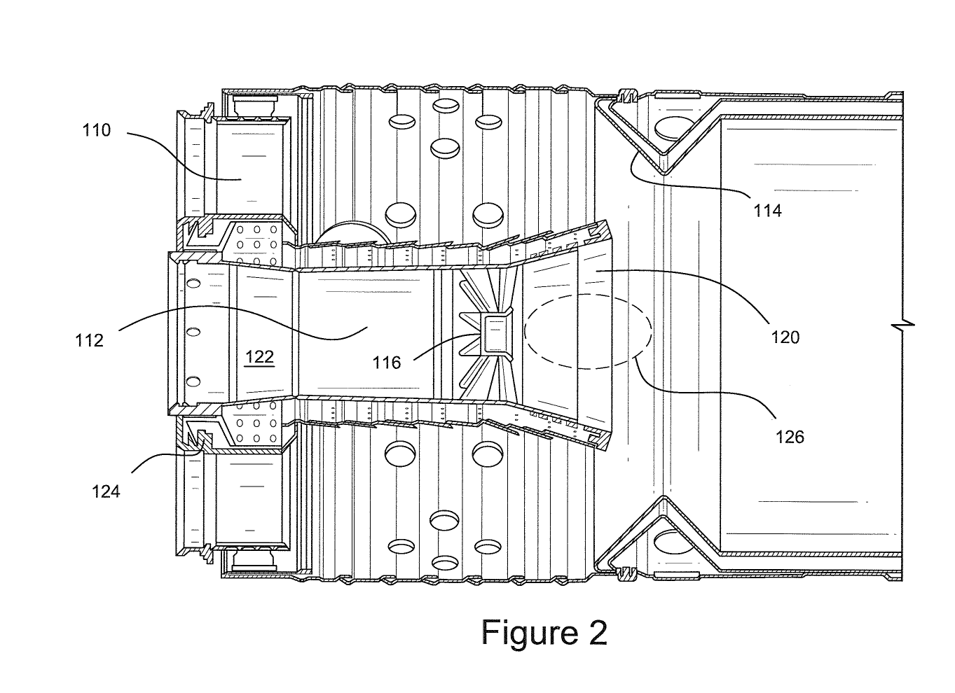

With reference to FIG. 2, the described configuration incorporates an axial swirler 116 whose outlet fits into an inlet of a diverging conical passage 120. This structure enables the swirled flow to expand, resulting in an aerodynamically stable and independent recirculation region with its boundary streamlines following the diverging outline of the conical passage 120.

The combustion system illustrated in FIG. 2, in an exemplary application, is an integral part of a dual-stage, dual-mode, low NOx combustion system for use in gas turbine engines. Like the conventional system, the illustrated system includes a plurality of primary fuel nozzles 110 arranged in an annular array around a secondary fuel nozzle 112. The primary nozzles 110 are separated from the secondary fuel nozzles by a venturi throat region 114.

The secondary fuel nozzle 112 or burner tube includes a premix passage 122 in fluid communication with a fuel delivery system via apertures 124 or the like. The premix passage 122 is preferably generally cylindrical. The swirler 116 is disposed downstream of the fuel delivery system in the premix passage 122. The conical diverging exit passage 120 is downstream of the swirler 116.

The flared exit passage 120 allows the swirled air to expand in a radial direction and form a recirculation region 126 (shown in dashed line) closer to the bluff body of the swirler 116 and at least partially within the space of the flare 120. A CFD simulation of the proposed modification demonstrates that the recirculation region 126 formed downstream of the swirler 116 is attached to the bluff body and does not extend passed the flare 120. The flow that goes out of the venturi throat region 114 does not influence the recirculation region 126 formed downstream of the swirler 116.

The secondary fuel nozzle 112 becomes an independent system in terms of flame stabilization. That is, it has its own recirculation region 126 independent of fluctuating aerodynamics downstream of the venturi throat region 114.

The described system improves the combustion stability of the combustor incorporating an axial swirler installed in the burner tube having a flare downstream of the swirler. The flare is designed to shape a recirculation region formed downstream of the swirler and localize it close to the bluff body of the swirler and within the space of the flare. The design extends the lean blowout and low frequency dynamics margins, which in turn allow a further reduction of NOx emissions by means of fuel split tuning.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A secondary fuel nozzle positionable among an annular array of primary fuel nozzles, the primary fuel nozzles being separated from the secondary fuel nozzle by a venturi throat region, the secondary fuel nozzle comprising:
a premix passage in fluid communication with a fuel delivery system;
a swirler disposed downstream of the fuel delivery system in the premix passage; and
a conical diverging exit passage downstream of the swirler.

2. A secondary fuel nozzle according to claim 1, wherein the conical diverging exit passage is sized and shaped to terminate prior to a minimum width of the venturi throat region.

3. A secondary fuel nozzle according to claim 1, wherein the premix passage is substantially cylindrical.

4. A secondary fuel nozzle according to claim 1, wherein the conical diverging exit passage is positioned relative to the venturi throat region and is sized and shaped such that a recirculation region is formed at least partially within a space defined by the conical diverging exit passage.

5. A combustor comprising:
a burner tube receiving fuel for combustion from a fuel delivery system; and
an axial swirler installed in the burner tube,
wherein the burner tube is flared downstream of the swirler.

6. A combustor according to claim 5, wherein the burner tube is substantially cylindrical.

7. A combustor according to claim 5, wherein the flared portion of the burner tube is sized and shaped such that a recirculation region is formed at least partially within a space defined by the flared portion of the burner tube.

8. A method of improving combustion stability in a combustor, the method comprising:
positioning a swirler in a burner tube that receives fuel for combustion from a fuel delivery system; and
designing a portion of the burner tube downstream of the swirler to define a recirculation region that extends lean blowout and low frequency dynamics margins of combustion.

9. A method according to claim 8, wherein the designing step comprises flaring the portion of the burner tube downstream of the swirler to define a conical diverging exit passage.

10. A method according to claim 9, wherein the recirculation region is formed at least partially within a space defined by the flared portion of the burner tube.
